(19) United States
(12) Patent Application Publication
(10) Pub. No.: US 2025/0111239 A1
(43) Pub. Date: Apr. 3, 2025

(54) Test Case Generation Through Reinforcement Learning With Static Code Quality Rewards

(71) Applicant: MICROSOFT TECHNOLOGY LICENSING, LLC., REDMOND, WA (US)

(72) Inventors: BENJAMIN STEENHOEK, DES MOINES, IA (US); ALEXEY SVYATKOVSKIY, BELLEVUE, WA (US); NEELAKANTAN SUNDARESAN, BELLEVUE, WA (US); MICHELE TUFANO, BELLEVUE, WA (US)

(21) Appl. No.: 18/516,937

(22) Filed: Nov. 21, 2023

Related U.S. Application Data
(60) Provisional application No. 63/541,286, filed on Sep. 28, 2023.

(51) Int. Cl. G06N 3/092

(52) U.S. Cl. CPC G06N 3/092

(57) ABSTRACT

A deep learning model is trained to learn to generate a better-quality unit test case for a focal method through reinforcement learning using a reward score that considers static code quality properties of a best coding standard. The static code quality properties include an assertion in the predicted unit test case, an invocation of the focal method in the predicted unit test case, and a descriptive name for the predicted unit test case. A reward model is trained to compute a reward score for a model-predicted unit test case based on the static code quality properties. The reward score is used in a proximal policy optimization method to produce a policy loss that updates the parameters of the deep learning model towards generating a better-quality unit test case.

### CROSS-REFERENCE TO RELATED APPLICATIONS

The present application claims the benefit of the earlier filed provisional application having Ser. No. 63/541,286, filed on Sep. 28, 2023, entitled “Test Case Generation via Reinforcement Learning From Static Quality Metrics,” which is incorporated by reference in its entirety.

### BACKGROUND

Large language models are a type of machine learning model used to perform a variety of tasks such as question answering, writing messages, fraud detection, spam filtering, malware thread detection, source code generation, and business process automation. A large language model is trained on massive amounts of data producing a model consisting of billions of parameters. The large language model is given a prompt which instructs the large language model on the task to be performed. The accuracy of the response from the large language model depends on how well the model was trained to perform the intended task.

Often, large language models are trained using classic loss functions, such as cross-entropy loss, which utilize a maximum likelihood objective to minimizes a loss used to adjust model weights. However, the training of a deep learning model based on classic loss functions does not capture the quality of the predicted output resulting in the model performing poorly by generating vague and/or useless responses.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A deep learning model, trained to predict a unit test case for a focal method through an old policy, is further optimized to learn a new policy that generates a better-quality unit test case through reinforcement learning based on static code quality properties. The static code quality properties for a unit test case include syntax correctness, existence of an assert statement, invocation of the focal method, existence of a descriptive method signature, existence of a comment, and the absence of anti-patterns.

The reinforcement learning uses the unit test cases generated from the model having an old policy and from unit test cases generated by the model trained through proximal policy optimization to compute a policy loss that optimizes the parameters of the deep learning model. A reward model analyzes the unit test case generated from the model optimized via reinforcement learning with respect to one or more static code quality properties and computes a reward score reflecting the quality of the unit test case generated from the model using the new policy. The reward score, based on the static code quality properties, and the difference between the two predicted unit test cases, is then used in a proximal policy optimization to generate a policy loss that is used to tune the parameters of the model to take actions that account for the static code quality properties.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary system for training a deep learning model to learn to predict a unit test case through reinforcement learning.

FIG. 2 is a schematic diagram illustrating an exemplary architecture of a deep learning model configured as a neural transformer model with attention trained to generate a unit test case using the old policy.

FIG. 3 is a schematic diagram illustrating an exemplary architecture of a neural transformer model with attention configured as the optimized deep learning model.

FIG. 4 is a schematic diagram illustrating an exemplary architecture of the reward model configured as a neural transformer model with attention.

FIG. 5 is a flow diagram illustrating an exemplary method for optimizing a deep learning model trained to generate a better-quality unit test case based on static code quality rewards.

FIG. 6 is a flow diagram illustrating an exemplary method for generating a fine-tuning dataset to train the deep learning model on a unit test case task.

FIG. 7 is a flow diagram illustrating an exemplary method for training the reward model on the static code quality rewards

FIG. 8 is a flow diagram illustrating an exemplary method for optimizing the parameters of the deep learning model via reinforcement learning.

FIG. 9 is a flow diagram illustrating an exemplary method for generating a unit test case using the optimized deep learning model.

FIG. 10 is a schematic diagram illustrating a first exemplary operating embodiment of the unit test generation system in a software development environment.

FIG. 11 is a block diagram illustrating a second exemplary operating environment.

FIG. 12 is a table illustrating performance metrics of the various RL-Models.

### DETAILED DESCRIPTION

### Overview

Aspects disclosed herein relate to tuning a deep learning model to learn to predict a unit test case through reinforcement learning. A deep learning model is pre-trained on source code and/or natural language text and fine-tuned to learn to predict unit test cases for a given focal method and its context. The fine-tuned model is then tuned via reinforcement learning to learn to predict better quality unit test cases that adhere to one or more user-selected static code quality properties. The static code quality properties represent a best practice standard for unit test cases. A reward model is created that generates a reward score indicating the quality of a model-generated unit test case with respect to the static code quality properties. A unit test case that adheres to the static code quality properties is given a high score while unit test cases that do not adhere to the static code quality properties are given a low score.

The reinforcement learning training uses the reward score in a proximal policy optimization method to adjust the parameters of the fine-tuned deep learning model to learn the actions that produce a better-quality unit test case. A unit test case is source code designed to test the behavior of a target source code (i.e., line of source code, method or class). The unit test case includes an assertion that defines the intended result of the test.

In an aspect, the static code quality properties for a unit test case includes syntax correctness, existence of an assertion in the test case, invocation of the target method in the test case, a descriptive method signature, the inclusion of a comment, and minimal anti-patterns.

An anti-pattern encompasses an issue with the implementation of the unit test case that can hinder the comprehensibility, maintainability and overall quality of a test suite. The existence of an anti-pattern can compromise the ability of a test case to uncover defects in the produced code, thereby reducing the reliability of the testing process. An example of an anti-pattern is where a test case contains duplicate assertions, conditional logic, exception handling, redundant prompt statements or an empty test case.

Classic loss functions, such as cross-entropy loss, utilize a maximum likelihood objective that minimizes the loss without considering the quality of the generated source code. The static code-quality properties generate a score based on one or more static code qualities, thereby providing a more accurate way to evaluate a model-predicted unit test case. A model-predicted unit test case could be completely different from the actual unit test case for a given focal method, in terms of token-by-token comparison, when evaluated using cross-entropy loss, yet still be considered a correct unit test case. The use of the quality reward score trains the model to learn to produce better quality test case code.

Reinforcement learning is a technique that uses a system of rewards and penalties to train a deep learning model to learn to solve a problem by itself. Reinforcement learning differs from supervised learning and unsupervised learning. In supervised learning, a model learns from a training dataset of labeled examples. Each sample in the training dataset contains a correct action that the model should take. The model learns to generalize its actions in order to act in situations not present in the training dataset. In unsupervised learning, the model learns to find patterns or structure hidden in the training dataset of unlabeled data. By contrast, reinforcement learning maximizes a reward gradually observed on its outputs during its training instead of trying to find hidden patterns and structure in the unlabeled training dataset.

The reward-based learning method differs from traditional training methods that optimize a maximum-likelihood loss or cost function (e.g., cross entropy loss). Instead, the reward-based learning method maximizes a specific, potentially discrete, non-differentiable reward instead of optimizing a maximum-likelihood loss function. The reward tells the neural network which action is wrong and which action is correct in order to learn to take actions that generate better quality source code.

In reinforcement learning, an actor interacts over time with its environment to achieve a goal and learns the actions that produce the most reward by trying them. The actor (e.g., deep learning model being tuned) observes the current state of the environment to decide which action to take (e.g., prediction of next token in a unit test case). The environment changes state and produces a reward for that action. The reward indicates whether the action was good or bad using the static code quality properties. A higher reward is given for an action that produces quality-generated source code. A penalty is imposed when the action is bad. The cycle of observation, action, and reward is repeated until the learning is complete.

The actor uses a function or policy that maps the inputs into the actions or outputs. The environment uses the reward as feedback on the action. The goal of the reinforcement learning phase is for the model to learn the optimal policy that maps a large set of observations into a set of actions that control the environment.

Proximal policy optimization (“PPO”) is a reinforcement learning technique that optimizes a surrogate objective function for performing stochastic gradient descent. A surrogate objective is one that approximates another objective or function. Surrogate optimization is used for time-consuming objective functions by taking a few evaluations in order to generate a good solution readily. This is also beneficial when there is limited tuning data for a target task.

In PPO, a policy gradient is computed to tune the parameters of the deep learning model. The goal of PPO is to limit large policy updates during tuning in order to avoid degrading the policy. In one aspect, the policy gradient is computed as a function of a clipped surrogate objective and a value function error term. The clipped surrogate objective minimizes the gradient to a lower bound so that the gradient updates are small. The value function is used by the model to estimate the reward for its own predictions. The value function error term is used to improve the estimation of value function, such that it can more accurately estimate the rewards for its predictions and, in turn, the model can generate predictions that maximize such reward.

In PPO, two interactive actors or deep learning models are used in the training with each model based on a different policy. A policy is a probability distribution of the actions aₜ given a state sₜ at time step t that an actor models. A fine-tuned (FT) deep learning model, FT-Model, is trained with a set of parameters ν_{OLD} and policy π to generate a unit test case given an input. A Reinforcement Learning (RL) trained model, RL-Model, is a deep learning model trained with a set of parameters ν_{NEW} and policy ρ that is tuned to generate a unit test case for a focal method. The RL-Model uses the parameters of the FT-Model initially which are then updated through PPO using a tuning dataset of unit test cases generated by each model.

In one aspect, the deep learning model is a neural transformer model with attention. Deep learning models differ from traditional machine learning models. Machine learning pertains to the use and development of computer systems that are able to learn and adapt without following explicit instructions, by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, support vector machines, and visual data mapping. Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks.

A neural transformer model with attention is one type of deep learning that utilizes an attention mechanism. Attention directs the neural network to focus on a subset of features or tokens in an input sequence thereby learning different representations from the different positions of the tokens in an input sequence. The attention mechanism provides the model with a better capability to learn the task at hand thereby generating more accurate predictions. It should be noted that the term neural transformer model with attention and neural transformer model are used interchangeably.

There are different configurations of a neural transformer model. In one aspect, the techniques are applied to a decoder-only configuration of a neural transformer model. The decoder-only neural transformer model is an auto-regressive model that produces an output one element at a time based on the outputs of previous time steps. Code generation, such as unit test case generation, is best suited for a decoder neural transformer model since it is an auto-regressive task that predicts an ordered sequence of tokens where the order depends on the preceding tokens in the sequence. The decoder uses a masked self-head attention which is best suited for auto-regressive tasks since it is explicitly trained to generate auto-regressively.

In one aspect, the techniques disclosed herein are discussed with regard to the generation of a unit test case given an input, such as a focal method and its associated context. However, it should be noted that this particular source code generation task is used to illustrate the disclosed techniques and should not be construed as limiting the technique to unit test case generation. The disclosed techniques may be applied to other source code generation tasks, such as, without limitation, code completion, docstring generation, method body generation, and the like.

Attention now turns to a more detailed description of the system, method, components, devices, used to train a deep learning model to generate or predict a better-quality unit test case.

### System

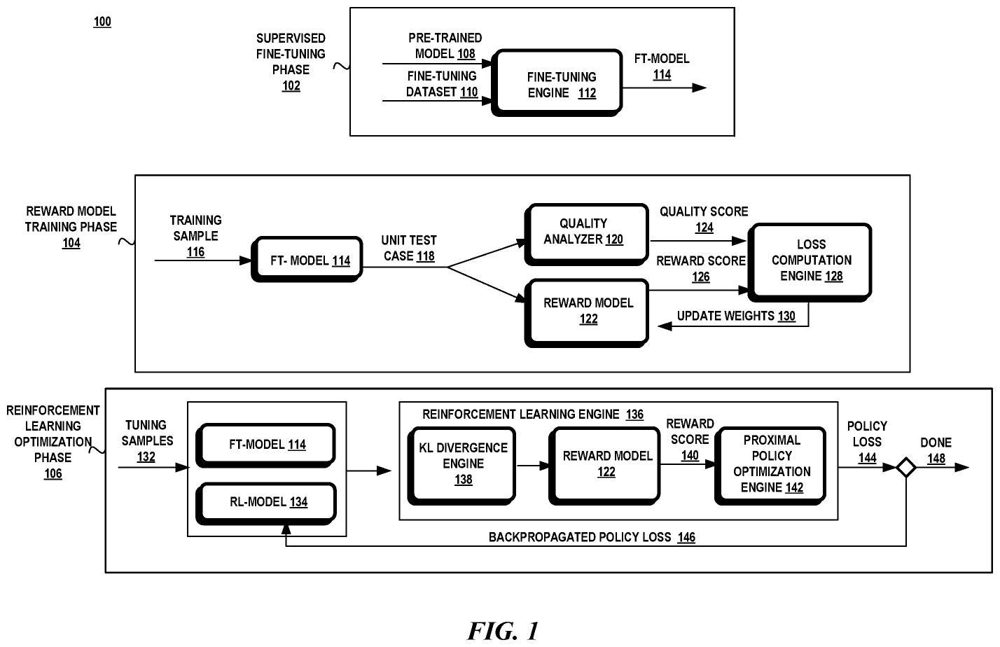

FIG. 1 illustrates a block diagram of an exemplary system 100 in which various aspects of the invention may be practiced. As shown in FIG. 1, system 100 includes various training phases: a supervised fine-tuning phase 102, a reward model training phase 104, and a reinforcement learning optimization phase 106. In the supervised fine-tuning phase 102, a deep learning model pre-trained to generate source code 108 is fine-tuned, using a fine-tuning engine 112 and a fine-tuning dataset 110, to learn to generate unit test cases. The deep learning model is trained in the supervised fine-tuning phase 102 using a cross-entropy loss objective function.

In the reward model training phase 104, a reward model 122 is trained to learn to predict a reward score that indicates the quality of a model-generated test case with respect to the static code quality properties. The reward model 122 is trained on test cases generated by the fine-tuned model, FT-Model 114 given a training sample 116. The model-generated unit test case 118 is then analyzed on the static code quality properties by a quality analyzer 120. The quality analyzer 120 generates a quality score 124 and the reward model generates a reward score 126. The loss computation engine 128 computes the difference between the two reward scores which is then used to update the parameters of the reward model 130.

In the reinforcement learning optimization phase 106, the fine-tuned deep learning model, FT-Model 114, is optimized through reinforcement learning to learn to predict better-quality unit test cases. The reinforcement learning model, RL-Model 134, is initialized with the parameters of the fine-tuned deep learning model, FT-Model 114. A set of tuning samples 132 is collected and input into both the fine-tuned model 114 and the current state of the RL-Model 134.

The distributions output from each of these models is then analyzed by the reinforcement learning engine 136. A KL-divergence engine 138 computes the difference between the two output distributions as a reward for each predicted token in the predicted unit test case. The reward model 122 generates a reward score 140 which is based on the static code quality properties. The adjusted reward score 140 is then used by the PPO engine 142 to generate a policy loss 144 that is backpropagated 146 to update the parameters of RL-Model 134. When the model training is completed 148, the RL-model 134 is deployed in an inference system to predict better quality unit test cases.

Attention now turns to a discussion of the reward model and the reinforcement-learning deep learning model.

Neural Transformer Model with Attention

Machine learning pertains to the use and development of computer systems that are able to learn and adapt without following explicit instructions by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. A neural transformer model with attention is one type of deep learning model that utilizes an attention mechanism. Attention directs the neural network to focus on a subset of features or tokens in an input sequence thereby learning different representations from the different positions of the tokens in an input sequence. The neural transformer model handles dependencies between its input and output with attention and without using recurrent neural networks (RNN) (e.g., long short-term memory (LSTM) network) and convolutional neural networks (CNN).

It should be noted that the term neural transformer model and neural transformer with attention model are used interchangeably. It should also be noted that the aspects disclosed herein are described with respect to neural transformer with attention models. However, the techniques are not limited to these types of neural networks and can be applied to other types of deep learning models that utilize an attention mechanism.

There are various configurations of a neural transformer model with each configuration suited for a particular software engineering task. The decoder-only neural transformer model is an auto-regressive model that produces an output one element at a time based on the outputs of previous time steps. Code generation is best suited for a decoder-only neural transformer model since it is an auto-regressive task that predicts an ordered sequence of tokens where the order depends on the preceding tokens in the sequence. The decoder uses a masked self-head attention which is best suited for auto-regressive tasks since it is explicitly trained to generate auto-regressively.

In an aspect, the large language model is pre-trained on natural language text and source code. The training of a large language model requires a considerable amount of training data and computing resources which makes it impossible for some developers to create their own models. The large language model consists of billions of parameters (e.g., weights, biases, embeddings) from being trained on terabytes of data. Examples of the large language models include the conversational pre-trained generative neural transformer models with attention offered by OpenAI i.e., ChatGPT and Codex models, PaLM and Chinchilla by Google, and LLaMa by Meta.

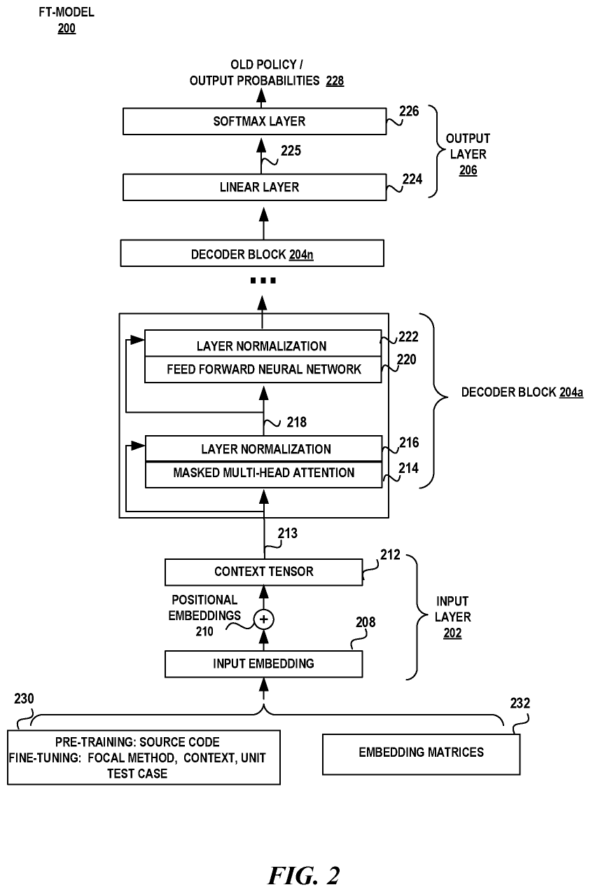

Turning to FIG. 2, there is shown an exemplary configuration of the fine-tuned model, FT-Model, as a decoder neural transformer model with attention 200 trained to generate a unit test case given an input.

A decoder neural transformer model 200 includes an input layer 202, one or more decoder blocks 204a-204n (“204”), and an output layer 206. The input or embedding layer 202 generates a context tensor 212 that is the sum of the token embeddings 208 and positional embeddings 210 of an input sequence.

The input embedding 208 for pre-training is a sequence of token embeddings representing source code samples 230. For fine-tuning, the input embedding 208 is a sequence of token embeddings representing a focal method, its context, and a corresponding unit test case 230. An embedding is a learned representation for the text-based tokens where tokens that have a common meaning have a common representation. An embedding is a mapping of discrete categorical variables to a vector of continuous numbers. There is an embedding for each token in the model's vocabulary and a corresponding positional embedding. The token embedding represents the learned representation for the token. The neural transformer model does not read each token sequentially and as such, has no knowledge of the token's position in a sequence without additional position information. The positional embedding is used to embed position information about a token's position in a sequence into a respective neural transformer model.

Initial values are generated for the token embedding and positional embeddings of each sequence which are then used to form a context tensor 212. Thereafter, the model learns the values for each embedding. Upon the completion of a training phase, the embeddings for each token and the positional embeddings are saved into respective matrices for later use (i.e., embedding store 232). There is a token embedding matrix, We, that contains an embedding vector for each token tᵢ, i=0 . . . . V, and a positional embedding matrix, Wp, that contains an embedding vector Pⱼ, j=0 . . . . T, for each position, where V is the size of the vocabulary and T is the length of the token sequence.

A decoder block 204 consists of two layers. The first layer includes a masked self-attention component 214 followed by a layer normalization component 216. The input to the masked multi-head self-attention component 213 has a residual connection to layer normalization 216. The output of layer normalization 218 is input into the feed forward neural network 220 with a residual connection to layer normalization component 222. The output of the feed forward neural network is input into layer normalization component 222.

The masked multi-head attention component 214 takes a context tensor 212 and weighs the relevance of each token represented in the context tensor 212 to each other by generating attention weights for each token in the context tensor 212. In one aspect, the attention function is scaled dot-product attention which is described mathematically as follows:

$$Attention ( Q , K , V ) = softmax ( \frac{Q {K}^{T}}{\sqrt{{d}_{k}}} ) V ,$$

where the input consists of queries Q and keys K of dimension dₖ, and values V of dimension dᵥ. Q is a matrix that contains the query or vector representation of one token in a sequence, K is the vector representations of all tokens in the sequence, and V is the vector representations of all the tokens in the sequence.

The queries, keys and values are linearly projected h times in parallel with dᵥ output values which are concatenated to a final value:

$$MultiHead ( Q , K , V ) = Concat ( {head}_{1} , … , {head}_{h} ) {W}^{o} ,$$

$$where {head}_{i} = Attention ( {QW}_{i}^{Q} , {KW}_{i}^{K} , {VW}_{i}^{V} ) ,$$

with parameter matrices Wᵢ^{Q}ϵ [symbol] , Wᵢ^{K}ϵ [symbol] , Wᵢ^{V}ϵ [symbol] and W^{O}ϵ [symbol] , where Wᵢ^{Q} are the query weights, Wᵢ^{K} are the key weights, Wᵢ^{V} are the value weights, and W^{O} are the weights of the concatenated output. Hence, the weights of the masked multi-head attention layer 214 are the parameter matrices, Wᵢ^{Q}, Wᵢ^{K}, Wᵢ^{V}, W^{O}.

Each token flows through all the decoder blocks along its own path. The masked self-attention component 214 allows the feed forward neural network 220 to focus on certain features or inputs. The decoder block 204 predicts each token tᵢ in the target language one-by-one at each time step conditioned on all previously-generated target tokens/tokens t₁, . . . tᵢ₋₁.

The masked self-attention component 214 masks the output embeddings from future time steps. The feed-forward neural network 220 processes each output embedding separately. A layer normalization component 216, 222 is used between the layers in order to normalize the inputs across the features.

The output layer 206 includes a linear layer 224 and a softmax layer 226. The linear layer 224 projects the vector produced by the stack of decoders into a logits vector 225. The softmax layer 226 then turns the scores of the logits vector 225 into output probabilities for each token in the model's vocabulary 228 which are positive and normalized.

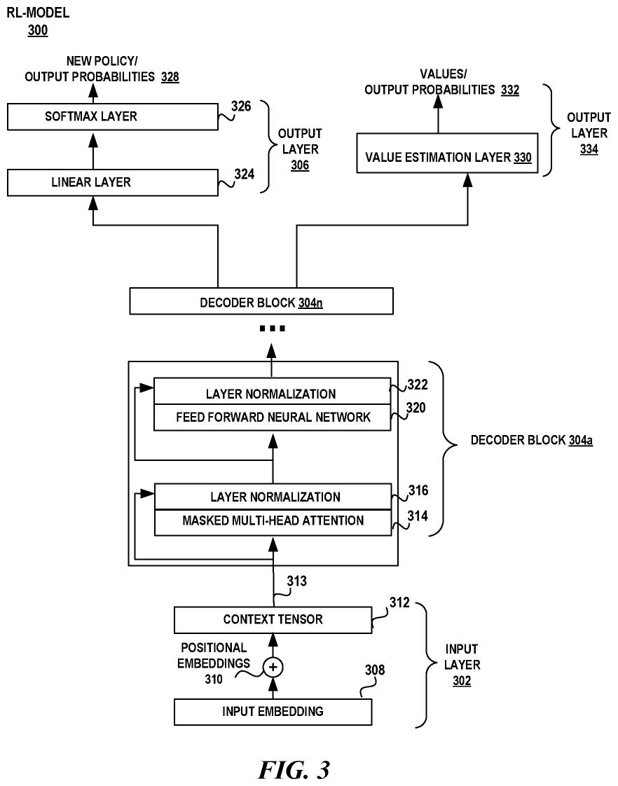

Turning to FIG. 3, there is shown an exemplary configuration of the reinforcement learning model, RL-Model, as a decoder neural transformer model with attention 300. The configuration of RL-Model is similar to the configuration of FT-Model except that during the reinforcement learning optimization phase, the RL-Model has an additional output layer 334.

The decoder neural transformer model 300 includes an input layer 302, one or more decoder blocks 304a-304n (“304”), output layer 306 and output layer 334. The input or embedding layer 302 generates a context tensor 312 that is the sum of the token embeddings 308 and positional embeddings 310 of an input sequence.

A decoder block 304 consists of two layers. The first layer includes a masked self-attention component 314 followed by a layer normalization component 316 that outputs 318. The second layer includes the feed forward neural network 320 and layer normalization component 322.

Output layer 306 generates an output distribution of the new policy 328. Output layer 306 includes a linear layer 324 and a softmax layer 326. Output layer 328 is used by the reinforcement learning engine. The value estimation layer 330 computes an additional scalar value output for each token νₜ. Value estimation layer 330 is composed of a linear feed-forward neural network layer with a hyperbolic tangent activation layer. The output of the value estimation layer 330 is a vector of action values νₜ that are input into the PPO engine for the computation of the policy loss.

It should be noted that during tuning, the parameters of each decoder block and output layers 306 and 334 are updated based on the policy loss as well as the parameters of the value estimation layer. The parameters of the value estimation layer are updated, in order to improve the model's estimation of the reward value of its own predictions, propagating the value error using stochastic gradient descent. Stochastic gradient descent operates using the overall loss over the entire model.

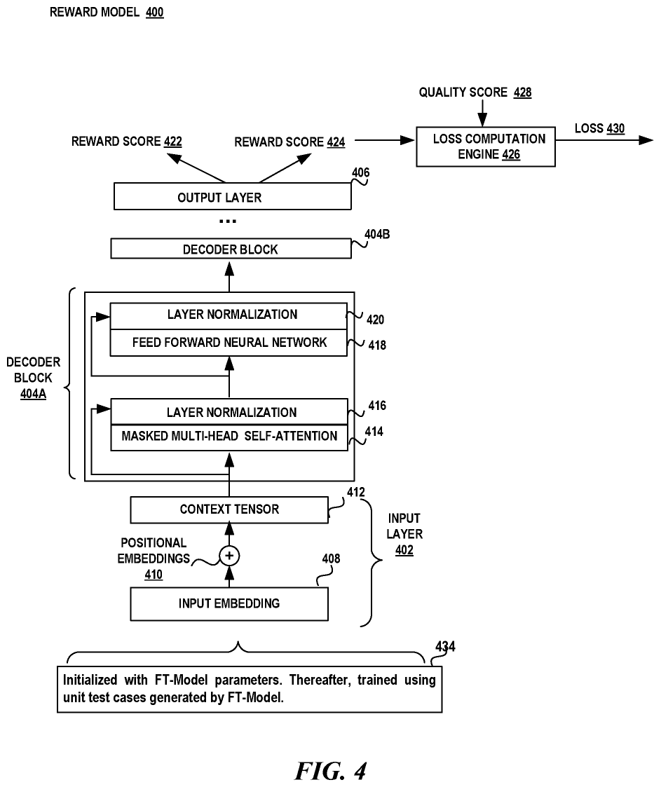

FIG. 4 is an illustration of an exemplary configuration of the reward model which is configured as a decoder neural transformer model with attention 400. The configuration of the reward model 400 is similar to the configuration of FT-Model shown in FIG. 2 except for the inputs and the output layers. The reward model 400 is initialized with the parameters of the fine-tuned model, FT-Model 434. During training, the reward model is given a unit test case generated by the FT-Model. The unit test case is input into the reward model which predicts a reward score 424. The unit test case is analyzed by the quality analyzer which generates a quality score 428. The loss computation engine 426 receives the reward score output by the reward model 424 and the quality score 428 output by the quality analyzer. The loss 430 computed by the loss computation engine 426 is then used to adjust the parameters of the reward model.

The decoder neural transformer model 400 includes an input layer 402, one or more decoder blocks 404a-404n (“404”), and an output layer 406. The input or embedding layer 402 generates a context tensor 412 that is the sum of the token embeddings 408 and positional embeddings 410 of an input sequence. The output layer 406 is a linear layer (e.g., neural network) which projects the vector produced by the decoder stack into a single scalar value, called the reward score, which represents the quality of the unit test case.

During the reinforcement learning optimization, the reward score 422 is output and used during reinforcement learning optimization to determine the loss that adjusts the model parameters.

The reward model includes one or more decoder blocks 404A-404B (“404”) with each decoder block 404 consisting of two layers. The first layer includes a masked self-attention component 414 followed by a layer normalization component 416. The second layer includes the feed forward neural network 418 and layer normalization component 420.

### Methods

Attention now turns to a description of the various exemplary methods that utilize the system and device disclosed herein. Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

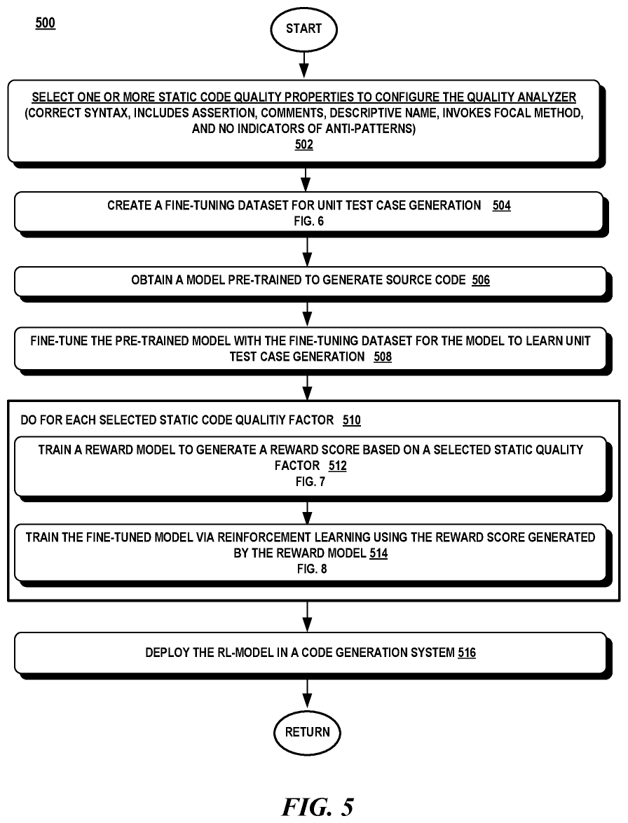

Turning to FIG. 5, there is shown an exemplary method 500 for training a deep learning model to generate best quality unit test cases.

Initially, a quality analyzer is configured to detect one or more static code quality properties (block 502). In an aspect, the static quality analyzer may be configured to detect a single static code quality property or multiple static code quality properties. The static code quality properties for a unit test case for a focal method include, syntax correctness, the inclusion of an assertion statement, the invocation of the focal method, the inclusion of at least one comment, a descriptive name for the unit test case, and the absence of anti-patterns, such as conditional logic code, exception handling code, print statements, and empty tests.

Anti-patterns include no duplicate assertion statements, no conditional logic or exception handling, no redundant print statements, and no empty tests. Test cases should not contain control statements, (e.g., if, switch or while statement), or exception handling (e.g., try/catch blocks) since conditional logic and exception handling are more complex to maintain and understand. Test cases should not contain print statement since unit test cases are executed as part of an automated process with little or no human intervention thereby making print statements unnecessary. Empty tests are test cases that contain no executable statements. These tests are problematic since they are passed even if they do not test any functionality of the program.

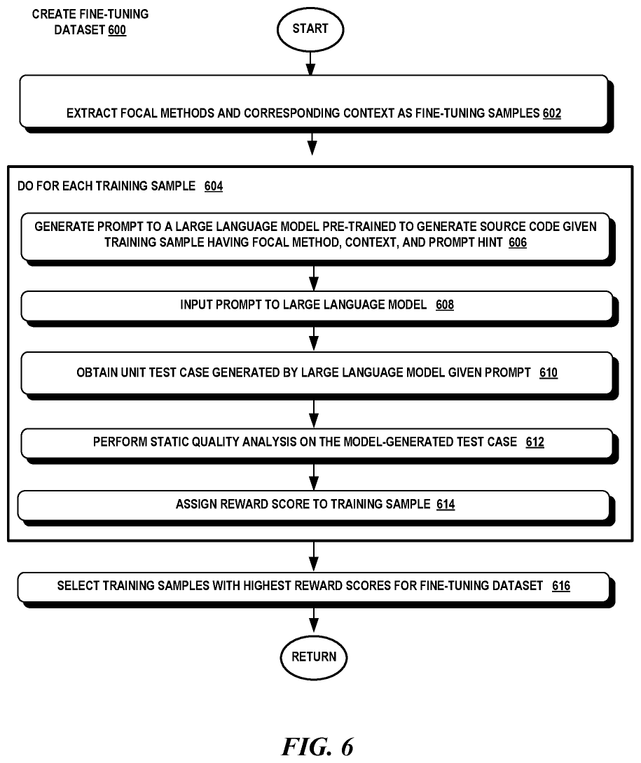

A fine-tuning dataset is created to train a deep learning model on the unit test case task which is described in further detail with respect to FIG. 6 (block 504). In an aspect, the deep learning model has been pre-trained to generate source code (block 506). The model is then fine-tuned with the training samples from the fine-tuning dataset (block 508).

Next, the reward model and the RL-model are trained on a single static code quality property (block 510). For each selected static code quality property (block 510), the reward model is trained to detect the selected static code quality property (block 512). Next, the fine-tuned deep learning model is optimized for the selected static code quality property using reinforcement learning (block 514).

Upon the completion of the reinforcement learning optimization, the RL-model is then deployed in a code generation system (block 516). Upon completion of the optimization of RL-Model, the model is then deployed in an inference system. In one aspect, the model may be deployed in a web service or application that generates unit test cases given an input, such as a method signature or a method body. In another aspect, the model may be part of a source code editor or integrated development environment (“IDE”) that generates unit test cases automatically upon initiation of a particular user input. In another aspect, the model may be part of an application that generates unit test cases for source code uploaded into a source code repository.

Turning to FIG. 6, there is shown an exemplary method for generating the training dataset for the unit test case generation task 600. Focal methods are selected from a source code repository with a corresponding context (block 602). For each focal method (block 604), a prompt is generated to obtain from the pre-trained deep learning model a corresponding unit test case for each focal method (block 606). A prompt is constructed that includes the focal method and its context. The context is extracted from various code elements. The context and the focal method have to fit within the length of the model's context window. For this reason, larger code elements are selected to fit into the prompt over smaller code elements. The code elements include the entire text of the comments of the focal method, the combination of the focal class, method signatures, fields and comments, the focal class and method signatures, and only the focal class.

The prompt is input into the pre-trained deep learning model (block 608) which returns a model-generated unit test case (block 610). The quality analyzer analyzes the model-generated unit test case with respect to the static code quality properties (block 612) and computes a quality score for the model-generated unit test case (block 614).

The quality analyzer utilizes a tree-sitter parser to transform the unit test case into a syntax tree from which the static code quality properties are identified. In an aspect, the quality analyzer gives a positive value for the presence of a static code quality property or the absence of an anti-pattern in the model-generated unit test case (e.g., 1), a neutral value if the code quality is absent or the anti-pattern is present (e.g., 0), and a negative value (e.g., −1) in the case that the model-generated unit test case is syntactically incorrect. A high-quality score indicates that the model-generated unit test case has exhibited most or all of the static code quality properties. A low-quality score indicates that the model-generated unit test case does not exhibit a lot of the static code quality properties, exhibits a lot of anti-patterns, or is syntactically incorrect.

It should be noted that a static code quality property differs from natural-language text quality properties, such as ROUGE and BLEU scores, and dynamic code quality properties that require the execution of the unit test case or the focal method, such as compilation rate and coverage. Static quality metrics, including syntax correctness and the presence of assert statements, rely solely on static code analysis tools, without the need for code execution; furthermore, these metrics can be computed or predicted by the model through the exclusive analysis of test cases without requiring knowledge of the entire system.

The training samples having the highest quality scores are then selected for the fine-tuning dataset (block 616).

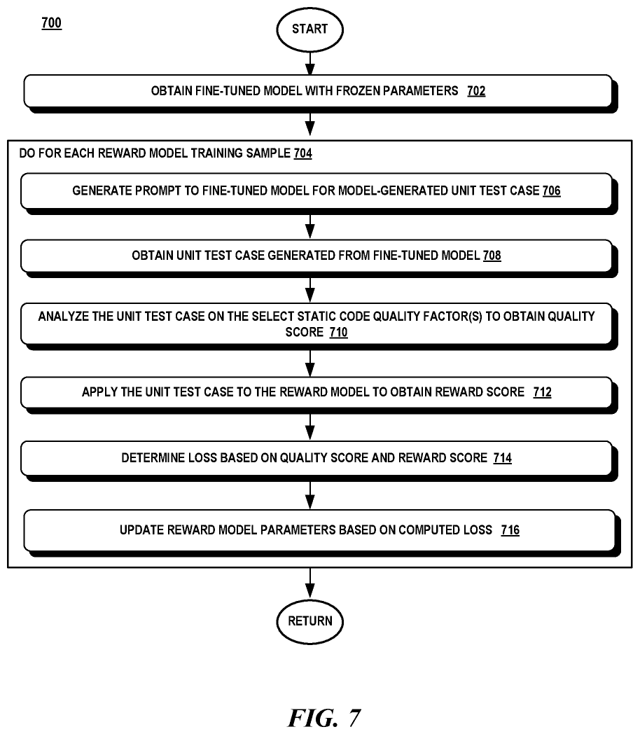

Attention now turns to a further discussion on the training of the reward model. Turning to FIG. 7, there is shown an exemplary method for training the reward model to learn to identify unit test cases having a select static code quality property 700. The fine-tuned deep learning model is used to generate unit test cases for a given focal method and context (block 702). The parameters of the fine-tuned deep learning model are frozen during the reward training.

For each training sample (block 704), a prompt is generated to the fine-tuned deep learning model for a unit test case for a given focal method and context (block 706). The model-generated unit test case is obtained (block 708) and analyzed by the quality analyzer with respect to the select static code quality property (block 710). The quality analyzer generates a quality score for the model-generated unit test case (block 710).

The model-generated unit test case is then analyzed by the reward model which generates a reward score (block 712). The two scores are analyzed by the loss computation engine which utilizes a loss function to determine a loss based on the quality score and the reward score (block 714). In an aspect, the loss function is based on a cross-entropy loss. The loss is then used to update the parameters of the reward model (block 716).

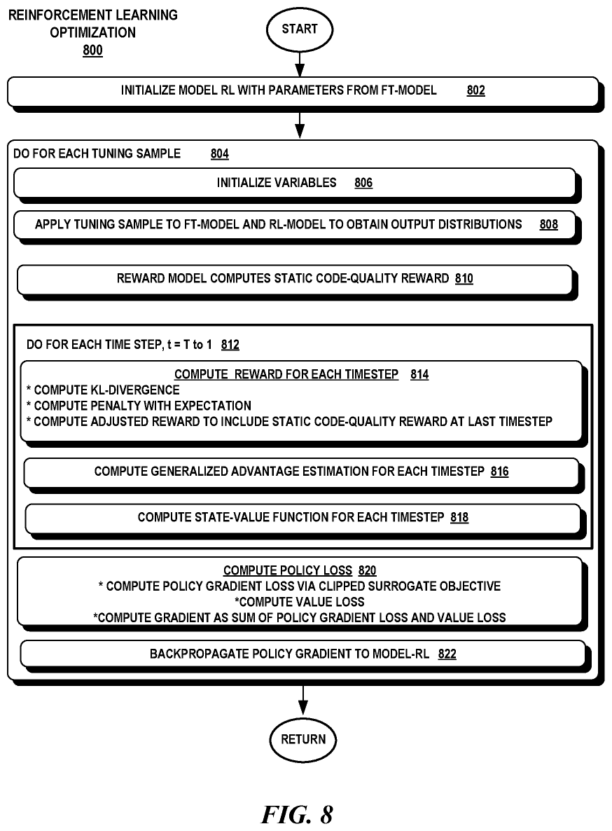

Attention now turns to a discussion of the reinforcement learning optimization using the reward model. Turning to FIG. 8, there is shown an exemplary method for the reinforcement learning optimization 800.

The method 800 alternates between sampling data using the old policy and the new policy and optimizing the new policy based on the sampled data. Sampling the data includes applying a tuning sample to both FT-Model and RT-Model, analyzing the two output distributions, generating a reward score for each action at each time step, and computing a corresponding state-value and an action-value. Optimizing the new policy includes determining a policy loss based on the sampled data and backpropagating the policy loss to the layers of the decoder blocks.

The goal of the policy loss is to optimize the expected total reward. Since there is a long-time delay from when the model predicts an action and knows the effect of that action on the reward, a generalized advantage function estimation is computed which estimates the goodness of the action before the delayed reward is known. The generalized advantage function estimation yields the lowest possible variance that the policy gradient applies to the model.

The generalized advantage estimation is based on a state-value function and an action-value function. A value is the total amount of rewards until reaching a terminal state. A state-value function returns a value of achieving a certain state and an action-value returns the value of choosing an action in a state. The value estimation layer of the RL-Model generates the values for the action-value function.

Initially, the fine-tuned model is duplicated into a second model, RL-Model, thereby initializing the RL-Model with the same trained parameters of FT-Model (block 802). The initial model parameters are then tuned through proximal policy optimization to learn to predict source code for the target task.

The variables used in the calculation of the loss are initialized at the start of each training iteration (block 806). In one aspect, these variables are initialized as follows: KL penalty coefficient β=0.02; and parameters for the generalized advantage function: γ=1.0 and λ=1.0 (block 806).

For each tuning sample (block 804), the focal method x is applied to both FT-Model and to RL-Model (block 808). The focal method x is transformed into an ordered sequence of tokens, tokenized, and then converted into a token embedding and related positional embedding. The token embedding and related positional embedding is concatenated into a context tensor. The context tensor is input into both the FT-Model and the RT-Model neural transformer model and passed through the multiple layers of each decoder block of each neural transformer model.

Each model is autoregressively predicting one token at each time step t to follow the previously predicted tokens in a predicted sequence y. Initially, each model receives a sequence of tokens token₀, . . . , token_{T-1} and at each timestep. The tokens in the output sequence are then shifted to the left and input back into the first decoder block. The number of timesteps t in this scenario is the number of tokens in a sequence or the sequence length T. (Collectively, block 808).

The PPO engine stores the output distribution of the FT-Model, π, from the last timestep T and the policy output at each timestep pₜ and the action-value νₜ from each timestep t, where t=1 . . . . T.

When the time step is the last time step T, a complete unit test case is predicted by the RL-Model which is then analyzed by the reward model using the static code quality properties (block 810). In one aspect, the static code quality reward, R (x, y) is computed as follows:

$$R ( x , y ) = α \cdot u ( y ) + β \cdot c ( y ) , \qquad ( 1 )$$

where α, β, γ are tunable parameters that give more weight to a particular static code-quality property, x is the given focal method, y is the RL-model predicted unit test case (block 810).

A reward is computed for each timestep t starting from the last time step T to the first-time step, t=T . . . 1. The reward for each timestep is based on the KL divergence between the old policy and the new policy. The static code-quality reward is added to the reward of the last timestep T.

For each timestep t, starting from the last time step T to the first-time step (block 812), the reward rₜ for the time step is computed (block 814). The reward function rₜ is represented mathematically as follows:

$${r}_{t} = - βlog \frac{π ( y \vert x )}{ρ ( y \vert x )} , for time step t < T , \qquad ( 2 )$$

$${r}_{t} = R ( x , y ) - βlog \frac{π ( y \vert x )}{ρ ( y \vert x )} , for time step t = T , \qquad ( 3 )$$

where

$$log \frac{π ( y \vert x )}{ρ ( y \vert x )}$$

is the ratio of the old policy π over the new policy ρ computed as the KL divergence between the two policies, where β is a tunable parameter that gives more weight to a penalty, and where x is the focal method and, y is the predicted unit test case output by the FT-Model.

Each model outputs a policy or output distribution. FT-Model outputs policy π(y|x) at time step t and RL-Model outputs policy ρ(y|x) at time step t. When the time step is not the last time step T, the reward is computed as in equation (2). The ratio of the old policy over the new policy

$$log \frac{π ( y \vert x )}{ρ ( y \vert x )}$$

quantifies the difference between the two probability distributions. The ratio represents the Kullback-Leibler (KL) divergence of the two probability distributions. The penalty βₜ is used to prevent the new policy ρ from diverging too far from the old policy π. (Collectively, block 814).

When the time step is the last, the reward is computed as in equation (3) above (block 814).

Next, an estimator of the generalized advantage function at each time step t is computed, Ât. The generalized advantage estimation at time step, t, is computed as using the reward at time t and the value function, vi, output from RL-Model. The generalized advantage estimation at time step t is represented mathematically as follows:

$${\hat{A}}_{t} = δ + γ \cdot λ \cdot {\hat{A}}_{t + 1} ,$$

where δ=rₜ+γ·νₜ₊₁−νₜ, where γ, λ are hyper-parameters which can be manually set to obtain different reinforcement learning models. The parameters' range is: γϵ[0,1], λϵ[0,1]. Specifically, the parameter γ is known as the discount factor, used to reduce the value of future tokens, and emphasize the value of the current sequences of tokens. This can be tuned to obtain shorter or longer sentences. Instead, λ is a smoothing parameter used for reducing the variance in training. (Collectively, block 816).

Next the state-value function is estimated (block 818). The state-value function of a state-action pair is an estimate of how good the model performs given an action in a given state. The state-value function at timestep t is computed as Vₜ^{targ}=Âₜ+νₜ.

Upon completion of the analysis of the sampled data at each temporal or time step, the policy loss is computed (block 820). The policy loss is computed as the sum of the clipped surrogate objective function and the value estimate error loss.

The policy loss computation is represented mathematically as follows:
L=L_{CLIP}+L_{VF}, where L_{CLIP} is the policy gradient loss via the clipped surrogate objective, L_{VF} is the computed squared error loss of the value estimates,

$${L}_{V F} = {\sum }_{t = 1}^{Num \_ tokens} {( {v}_{t} - {V}_{r}^{targ} )}^{2} ,$$

$${L}_{CLIP} = {\sum }_{t = 1}^{Num \_ tokens} min ( {r}_{t} {\hat{A}}_{t} , clip ( {r}_{t} , 1 - ϵ , 1 + ϵ ) \cdot {\hat{A}}_{t} ) .$$

Once the policy loss L is calculated, the policy loss is propagated backwards to each layer of each decoder block that contributed directly to the output. In backpropagation, the partial derivatives of the policy gradient with respect to the trainable parameters are determined. The weight gradients for the parameters are calculated as the difference between the old values and the new values of the weights. The weights are adjusted to make the loss as small as possible using a stochastic gradient descent technique. (Collectively, block 822).

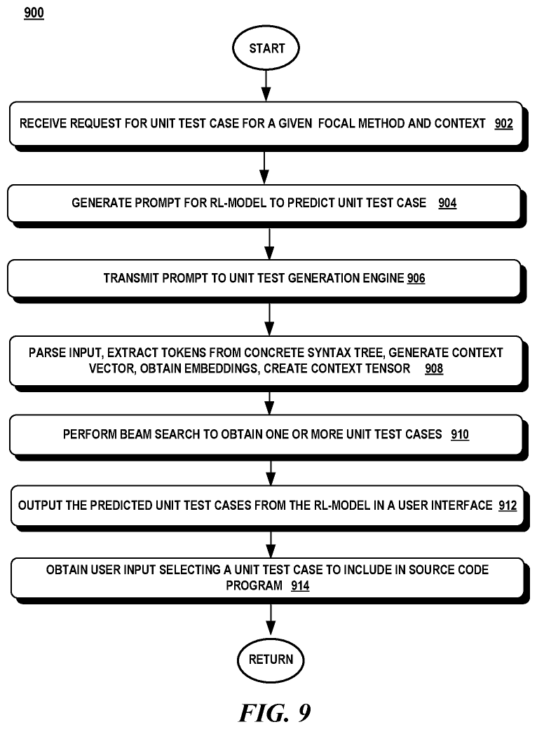

Attention now turns to a more detailed description of the inference process where the optimized RL-Model is used to generate a unit test case. Turning to FIG. 9, there is shown an exemplary method 900 for generating a unit test case utilizing the RL-Model. In an aspect, the method is implemented in an application, such as a web browser, web service, source code editor, software development environment, or other application that accepts source code.

A request is received by the application for a unit test case given a focal method and a corresponding context (block 902). A prompt is generated for the RL-Model to produce the unit test case (block 904). The prompt includes the focal method, its context, and a prompt hint (block 906).

The prompt is given to the large language model which returns one or more candidate unit test cases (block 906). In an aspect, the large language model may be hosted by a web service and accessed using an Application Programming Interface (“API”) that is transmitted to an endpoint of the web service via the Internet. The API contains the prompt. In another aspect, the large language model may reside in the same computing device as the unit test case generation system.

The focal method, its context, and the prompt hint are parsed into a concrete syntax tree, from which tokens are extracted, and then transformed into a sequence of token and positional embeddings that form a context tensor (block 908). A beam search is then performed to obtain the candidate unit tests cases (block 910).

The beam search uses the probability distributions generated by the RL-Model to identify the top tokens likely to be the next token in a candidate sequence. The beam search expands the search by instantiating new partial sequences using each of the selected tokens identified by the RL-Model's probability distribution. The search continues generating new partial sequences from the top tokens identified by the output distributions from the RL-Model until the search ends. The search may end when the end-of-method token appears as the most probable next token or another search termination event occurs. (Collectively, block 910).

A beam search uses a breadth-first search to build a search tree. The search tree is composed of nodes at one or more inference levels. Each node represents a probability distribution generated by the neural transformer model for the tokens in the model vocabulary. At each level, only the top k tokens having the highest probabilities from the output distribution generated by the neural transformer model with attention are expanded to the next inference level. The variable k is preconfigured and referred to as the beam width. Each of the k tokens is then expanded into a search that updates the current coverage symbol sequence with the selected token to input into the neural transformer model with attention to generate an additional probability distribution for the next token in a sequence. This process is repeated until a termination event occurs. (Collectively, block 910).

One or more candidate unit test cases may be produced by the beam search and the RL-Model which are output in a user interface (block 912). A user may select one of the unit test cases which is input into a source code program (block 914).

### Inference

Attention now turns to a discussion of a first exemplary operating environment. In an aspect, unit test case generation is embodied as a function or feature integrated into a source code development tool 1000, such as source code editor, integrated development environment (IDE), browser, and/or stand-alone application. In an aspect, the source code development tool 1000 may include a user interface 1002, a prompt generator 1004, and a unit test case generation engine 1006.

The user interface 1002 includes a set of features or functions for developing (e.g., writing, editing, testing) a source code program. The user interface 1002 may include a window that is used to interact with a developer during the development of a source code program.

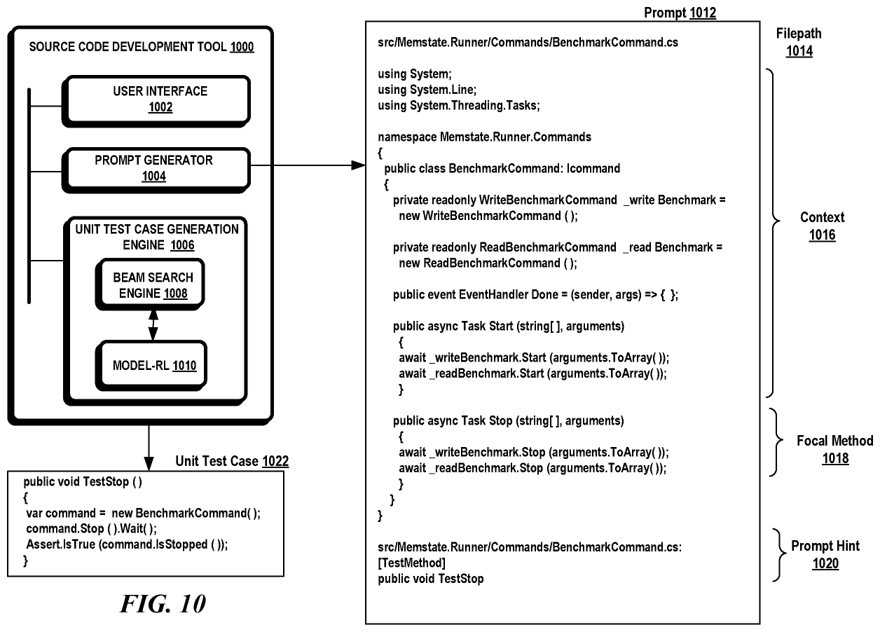

At certain points in the development process, the developer will request candidates from the unit test case generation engine 1006 to generate a unit test case for a focal method. The prompt generator 1004 generates a prompt 1012 that includes the file path of the source code program 1014, the context of the focal method 1016, the focal method 1018 and a prompt hint 1020. In the example shown in FIG. 10, the focal method is the method Task Stop. The context includes the class BenchmarkCommand and the class methods EventHandler and Task Start. The prompt hint 1020 includes a start of the unit test case which the RL-Model completes.

The unit test case generation engine 1006 generates the unit test case 1022 given the prompt. The unit test case generation engine 1006 performs a beam search until an end-of-method token is reached or other termination event occurs. The top candidate unit test cases are returned to the user interface 1002.

The user interface 1002 may display the top unit test cases in a pop-up window in the user interface 1002 or alternatively display a single unit test case inserted into the current source code program. If the developer wants to accept a unit test case, the developer may type in a particular keystroke or combination of keystrokes to accept the unit test case which is then automatically inserted into the source code program.

### Exemplary Operating Environment

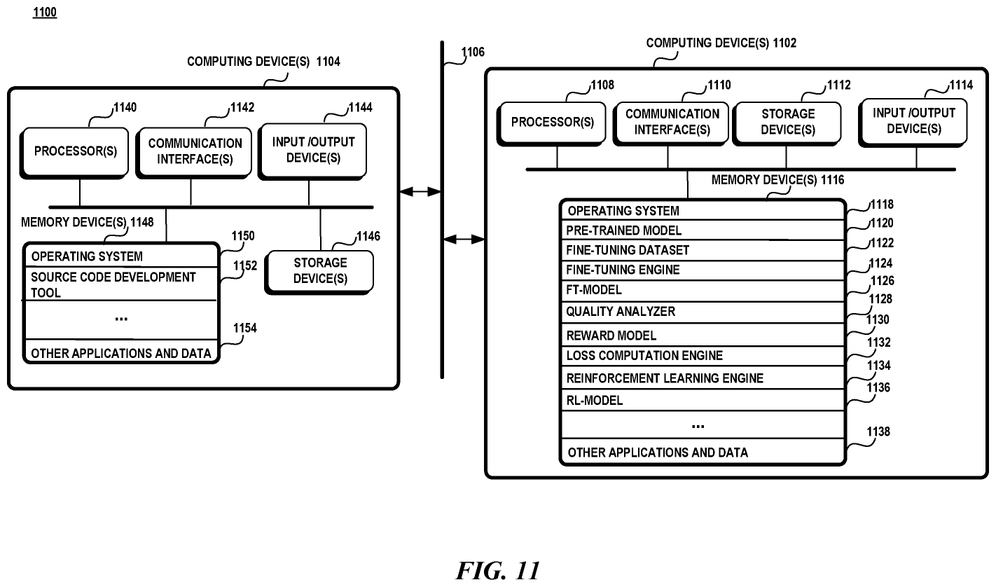

Attention now turns to a discussion of an exemplary operating environment. FIG. 11 illustrates an exemplary operating environment 1100. In one embodiment, the training of the deep learning model and the usage of the model in an inference system may be performed on a single device.

In an alternate embodiment, the training system may be configured as a cloud service that trains and/or operates the RL-Model as a service. A client device may transmit to the cloud service the training samples and the cloud service may tune the model. The interaction between the client device and the cloud service may be performed through various APIs. The trained model may then be operated either on the client device or in the cloud service.

In an alternate embodiment, the RL-Model may be hosted as a web service that interacts with a developer computing device hosting the software development tool. The software development tool interacts with the web service hosting the RL-model through APIs.

The computing devices 1102, 1104 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 1100 may be configured in a network environment, a distributed environment, a multi-processor environment, or a stand-alone computing device having access to remote or local storage devices.

A computing device 1102, 1104 may include one or more processors 1108, 1140, one or more communication interfaces 1110, 1142, one or more storage devices 1112, 1146, one or more input/output devices 1114, 1142, and one or more memory devices 1116, 1148. A processor 1108, 1140 may be any commercially available or customized processor and may include dual microprocessors and multi-processor architectures. A communication interface 1110, 1142 facilitates wired or wireless communications between the computing devices 1102, 1104 and other devices. A storage device 1112, 1146 may be computer-readable medium that does not contain propagating signals, such as modulated data signals transmitted through a carrier wave. Examples of a storage device 1112, 1146 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1112, 1146 in the computing devices. The input/output devices 1114, 1144 may include a keyboard, mouse, pen, voice input device, touch input device, display, speakers, printers, etc., and any combination thereof.

A memory device or memory 1116, 1148 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 1116, 1148 may also include one or more external storage devices or remotely located storage devices that do not pertain to propagated signals, such as modulated data signals transmitted through a carrier wave.

The memory device 1116, 1148 may contain instructions, components, and data. A component is a software program that performs a specific function and is otherwise known as a module, program, component, and/or application. Memory device 1116 may include an operating system 1118, a pre-trained model 1120, a fine-tuning dataset 1122, a fine-tuning engine 1124, the FT-Model 1126, the quality analyzer 1128, the reward model 1130, a loss computation engine 1132, a reinforcement learning engine 1134, the RL-model 1136, and other applications and data 1138. Memory device 1148 may include an operating system 1150, a source code development tool 1152, and other applications and data 1154.

The computing devices 1102, 1104 may be communicatively coupled via a network 1106. The network 1106 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 1106 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Significant Improvements

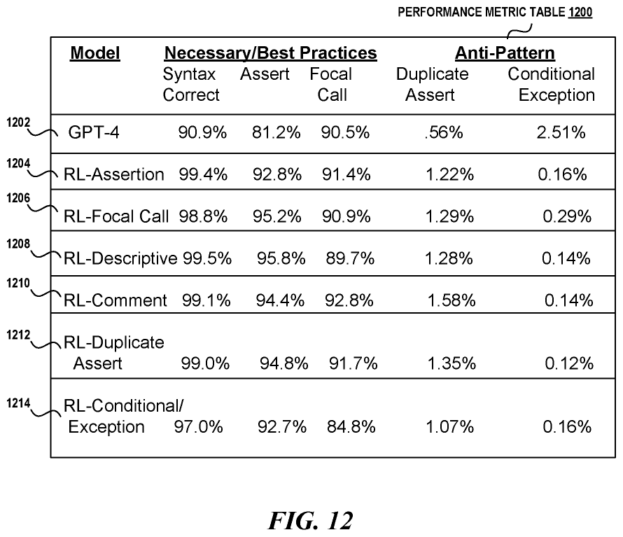

Attention now turns to a discussion of the performance improvement of the techniques described herein over previous techniques. Turning to FIG. 12, there is shown a table of the performance metrics of the disclosed system with respect to the Generative Pre-Trained Transformer 4 (“GPT-4”) 1202 and various RL-models trained on a single target static code quality property. The static code quality properties measured are syntax correctness (Syntax Correct), the inclusion of an assert statement (Assert), the invocation of the focal method (Focal call), the absence of a duplicate assert (Duplicate Assert) and the absence of conditional logic and exception handling (Conditional/Exception).

The RL-models are compared with respect to GPT-4. GPT-4 is a large multi-modal language model developed by OpenAI trained to generate image, text, and source code. There are six RL-Models where each is trained to generate a reward score for a single specific static code quality property or anti-pattern. There is an RL-Assertion model trained on the Assertion static code quality property 1204, an RL-Focal Call model trained on the Focal Call static code quality property 1206, an RL-Descriptive model trained on the Descriptive static code quality property 1208, an RL-Comment model trained on the Comment static code quality property 1210, an RL-Duplicate Assert model trained on the Duplicate Assert anti-pattern 1212, and an RL-Conditional/Exception model trained on the Conditional/Exception anti-pattern 1214.

As shown in Table 1200, the GPT-4 model 1202 generates unit test cases that are syntactically correct 90.9% of the time, includes an assertion 81.2% of the time, includes an invocation of the focal method 90.5% of the time, contains a duplicate assertion 0.56% of the time, and contains conditional logic or exception handling code 2.5% of the time.

By contrast, the RL-models outperform the GPT-4 model for each of the metrics. The RL-Assertion model optimized for the Assertion property 1204, generates unit test cases that are syntactically correct 99.4% of the time, generates unit test cases that include an assertion 92.8% of the time, generates unit test cases that include an invocation of the focal method 91.4% of the time, generates unit test cases that contain a duplicate assertion 1.22% of the time, and generates unit test cases that contain conditional logic or exception handling code. 16% of the time.

The RL-Focal Call model optimized for the Focal call property 1206, generates unit test cases that are syntactically correct 98.8% of the time, generates unit test cases that include an assertion 95.2% of the time, generates unit test cases that include an invocation of the focal method 90.9% of the time, generates unit test cases that contain a duplicate assertion 1.29% of the time, and generates unit test cases that contain conditional logic or exception handling code. 29% of the time.

The RL-Descriptive model optimized for the Descriptive property 1208, generates unit test cases that are syntactically correct 99.5% of the time, generates unit test cases that include an assertion 95.8% of the time, generates unit test cases that include an invocation of the focal method 89.7% of the time, generates unit test cases that contain a duplicate assertion 1.28% of the time, and generates unit test cases that contain conditional logic or exception handling code. 14% of the time.

The RL-Model optimized for the Comment property 1210, generates unit test cases that are syntactically correct 99.1% of the time, generates unit test cases that include an assertion 94.4% of the time, generates unit test cases that include an invocation of the focal method 92.8% of the time, generates unit test cases that contain a duplicate assertion 1.58% of the time, and generates unit test cases that contain conditional logic or exception handling code 14% of the time.

The RL-Model optimized for the Duplicate Assert anti-pattern 1212, generates unit test cases that are syntactically correct 99.0% of the time, generates unit test cases that include an assertion 94.8% of the time, generates unit test cases that include an invocation of the focal method 91.7% of the time, generates unit test cases that contain a duplicate assertion 1.35% of the time, and generates unit test cases that contain conditional logic or exception handling code 12% of the time.

The RL-Model optimized for the Conditional/Exception anti-pattern 1214, generates unit test cases that are syntactically correct 97.0% of the time, generates unit test cases that include an assertion 92.7% of the time, generates unit test cases that include an invocation of the focal method 84.8% of the time, generates unit test cases that contain a duplicate assertion 1.07% of the time, and generates unit test cases that contain conditional logic or exception handling code. 16% of the time.

Hence, the training of the deep learning model on one or more of the static code quality properties generates better-quality unit test cases.

### Technical Effect

Aspects of the subject matter disclosed herein pertain to the technical problem of training a deep learning model to learn to generate better-quality unit test cases that adhere to a coding best practice standard. The technical feature associated with addressing this problem is the optimization of the deep learning model through reinforcement learning using static code quality properties that represent the coding best practice standards. The reward model scores the model-generated unit test cases based on one or more static code quality properties which is used as feedback for the PPO method to adjust the model parameters towards generating a better-quality unit test case. In this manner, when the deep learning model operates on a computing device during inference, it will consume less resources and time to generate a better-quality unit test case thereby improving the functioning of the computing device. Additionally, the techniques described herein are an improvement to the technology of unit test case generation.

One of ordinary skill in the art understands that the techniques disclosed herein are inherently digital. The operations used to generate the reward model, to train the deep learning model using the reward score output from the reward model, and the use of the reinforcement-learning trained large language model to predict a unit test case are inherently digital. The human mind cannot interface directly with a CPU or network interface card, or other processor, or with RAM or other digital storage, to read or write the necessary data and perform the necessary operations disclosed herein.

The embodiments are also presumed to be capable of operating at scale, within tight timing constraints in production environments (e.g., version-control source code repository), and in testing labs for production environments as opposed to being mere thought experiments. Hence, the human mind cannot perform the operations described herein in a timely manner and with the accuracy required for these intended uses.

### CONCLUSION

A system is disclosed comprising: a processor; and a memory that stores a program configured to be executed by the processor, the program includes instructions to perform actions that: obtain a reward model trained to generate a reward score for a model-generated unit test case for a focal method, wherein the reward score is based on a unit test case having one or more static code quality properties, wherein the one or more static code quality properties comprise an assertion, an invocation of the focal method, a name for the unit test case that describes the test case, and/or the existence of a comment that describes the test case; obtain a deep learning model trained to learn to generate a unit test case, wherein parameters of the deep learning model are learned through a cross-entropy loss; and tune the parameters of the deep learning model to learn to generate a unit test case having the one or more static code quality properties through reinforcement learning, wherein the reinforcement learning generates a policy loss that is based on a reward that comprises a reward score from the reward model for a unit test case generated by the tuned deep learning model for a given tuning sample, wherein the policy loss is backpropagated through the tuned deep learning model.

In an aspect, the program includes instructions to perform actions that: deploy the tuned deep learning model in a source code development system to generate a target unit test case for a given target focal method.

In an aspect, the one or more static code quality properties comprises syntax correctness of the unit test case generated by the tuned first deep learning model. In an aspect, the one or more static code quality properties comprises an absence of a duplicate assertion in the unit test case generated by the tuned first deep learning model. In an aspect, the one or more static code quality properties comprise an absence of conditional logic or exception handling code in the unit test case generated by the tuned first deep learning model. In an aspect, the one or more static code quality properties comprise an absence of a print statement and/or an empty test in the unit test case generated by the tuned first deep learning model.

In an aspect, the reward model is a neural transformer model with attention. In an aspect, the deep learning model is a neural transformer model with attention.

A computer-implemented method is disclosed, comprising: obtaining a reward model trained to generate a reward score for a model-generated unit test case for a focal method, wherein the quality score is based on a unit test case having a plurality of static code quality properties, wherein the plurality of static code quality properties comprises an assertion, an invocation of the focal method, a name for the unit test case that describes the test case, and/or the existence of a comment that describes the test case; fine-tuning a large language model to learn to generate a unit test case for a given focal method and context of the focal method, wherein the large language model was pre-trained to generate source code; tuning the large language model to learn to generate a unit test case having the plurality of static code quality properties, wherein the tuning uses a policy gradient method to determine a policy loss that is backpropagated to layers of the tuned large language model, wherein the policy loss is based on a reward having a reward score generated by the reward model for a unit test case generated by the tuned large language model for a given tuning sample; and deploying the tuned large language model in a software development environment to predict a target unit test case for a target focal method.

In an aspect, the plurality of static code properties further comprises one or more anti-pattern properties, wherein an anti-pattern property comprises existence of a duplicate assertion in the unit test case generated by the tuned large language model. In an aspect, the one or more anti-pattern properties further comprise existence of conditional logic or exception handling code in the unit test case generated by the tuned large language model. In an aspect, the one or more anti-pattern properties further comprise existence of a print statement in the unit test case generated by the tuned large language model. In an aspect, the one or more anti-pattern properties further comprise existence of an empty test in the unit test case generated by the tuned large language model.

In an aspect, the computer-implemented method further comprises: generating the reward score as a combination of positive values for existence of the assertion, invocation of the focal method, and existence of the name for the unit test case that describes the test case or the absence of anti-patterns and a negative value for each unit test case which is syntactically incorrect. In an aspect, the reward model is a neural transformer model with attention.

A hardware storage device is disclosed having stored thereon computer executable instructions that are structured to be executable by a processor of a computing device to thereby cause the computing device to perform actions for: accessing a reward model trained to generate a reward score for a model-generated unit test case for a focal method, wherein the reward score is based on a unit test case having one or more of a plurality of static code quality properties, wherein the plurality of static code quality properties comprises an assertion, an invocation of the focal method, a name for the unit test case that describes the test case, and/or the existence of a comment that describes the test case; accessing a neural-based model trained to generate a unit test case for a focal method, wherein the neural-based model comprises a plurality of parameters generated via a cross-entropy loss; and tuning the neural-based model to learn to predict a unit test case for a target focal method having one or more of the plurality of static code quality properties, wherein the tuning of the neural-based model comprises: iteratively sampling a predicted unit test case generated by the neural-based model and a predicted unit test case generated by the tuned neural-based model for a tuning sample; computing, by the reward model, a reward score for the predicted unit test case generated by the tuned neural-based model; computing a reward-based loss for the predicted unit test case generated by the neural-based model and the predicted unit test case generated by the tuned neural-based model; augmenting the reward-based loss with the reward score; and updating parameters of the tuned neural-based model using a policy loss that is based on the augmented reward-based loss.

In an aspect, the plurality of static code quality properties further comprises a plurality of anti-patterns, wherein the plurality of anti-patterns comprises existence of a duplicate assertion, existence of conditional logic or exception handling code, existence of print statement, and/or existence of an empty test in the unit test case generated by the tuned neural-based model.

In an aspect, the reward model is trained to generate the reward score for a select one of the static code quality properties. In an aspect, the neural-based model comprises a neural transformer model with attention. In an aspect, the reward model comprises a neural transformer model with attention.

It may be appreciated that the representative methods described herein do not necessarily have to be executed in the order presented, or in any particular order, unless otherwise indicated. Moreover, various activities described with respect to the methods can be executed in serial or parallel fashion, or any combination of serial and parallel operations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
a processor; and
a memory that stores a program configured to be executed by the processor, the program includes instructions to perform actions that:
obtain a reward model trained to generate a reward score for a model-generated unit test case for a focal method, wherein the reward score is based on a unit test case having one or more static code quality properties, wherein the one or more static code quality properties comprise an assertion, an invocation of the focal method, a name for the unit test case that describes the test case, and/or the existence of a comment that describes the test case;
obtain a deep learning model trained to learn to generate a unit test case, wherein parameters of the deep learning model are learned through a cross-entropy loss; and
tune the parameters of the deep learning model to learn to generate a unit test case having the one or more static code quality properties through reinforcement learning, wherein the reinforcement learning generates a policy loss that is based on a reward that comprises a reward score from the reward model for a unit test case generated by the tuned deep learning model for a given tuning sample, wherein the policy loss is backpropagated through the tuned deep learning model.

2. The system of claim 1, wherein the program includes instructions to perform actions that:
deploy the tuned deep learning model in a source code development system to generate a target unit test case for a given target focal method.

3. The system of claim 1, wherein the one or more static code quality properties comprises syntax correctness of the unit test case generated by the tuned first deep learning model.

4. The system of claim 1, wherein the one or more static code quality properties comprises an absence of a duplicate assertion in the unit test case generated by the tuned first deep learning model.

5. The system of claim 1, wherein the one or more static code quality properties comprise an absence of conditional logic in the unit test case generated by the tuned first deep learning model.

6. The system of claim 1, wherein the one or more static code quality properties comprise an absence of exception handling code, a print statement, and/or an empty test in the unit test case generated by the tuned first deep learning model.

7. The system of claim 1, wherein the reward model is a neural transformer model with attention.

8. The system of claim 1, wherein the deep learning model is a neural transformer model with attention.

9. A computer-implemented method, comprising:
obtaining a reward model trained to generate a reward score for a model-generated unit test case for a focal method, wherein the quality score is based on a unit test case having a plurality of static code quality properties, wherein the plurality of static code quality properties comprises an assertion, an invocation of the focal method, a name for the unit test case that describes the focal method, and/or the existence of a comment that describes the test case;
fine-tuning a large language model to learn to generate a unit test case for a given focal method and context of the focal method, wherein the large language model was pre-trained to generate source code;
tuning the large language model to learn to generate a unit test case having the plurality of static code quality properties, wherein the tuning uses a policy gradient method to determine a policy loss that is backpropagated to layers of the tuned large language model, wherein the policy loss is based on a reward having a reward score generated by the reward model for a unit test case generated by the tuned large language model for a given tuning sample; and
deploying the tuned large language model in a software development environment to predict a target unit test case for a target focal method.

10. The computer-implemented method of claim 9, wherein the plurality of static code properties further comprises one or more anti-pattern properties, wherein an anti-pattern property comprises existence of a duplicate assertion in the unit test case generated by the tuned large language model.

11. The computer-implemented method of claim 10, wherein the one or more anti-pattern properties further comprise existence of conditional logic or exception handling code in the unit test case generated by the tuned large language model.

12. The computer-implemented method of claim 11, wherein the one or more anti-pattern properties further comprise existence of a print statement in the unit test case generated by the tuned large language model.

13. The computer-implemented method of claim 12, wherein the one or more anti-pattern properties further comprise existence of an empty test in the unit test case generated by the tuned large language model.

14. The computer-implemented method of claim 10, further comprising:
generating the reward score as a combination of positive values for existence of the assertion, invocation of the focal method, existence of the name for the unit test case that describes the test case, and existence of a comment that describes the test case or the absence of anti-patterns, and a negative value for each syntactically incorrect unit test case generated by the tuned first large language model.

15. The computer-implemented method of claim 9, wherein the reward model is a neural transformer model with attention.

16. A hardware storage device having stored thereon computer executable instructions that are structured to be executable by a processor of a computing device to thereby cause the computing device to perform actions for:
accessing a reward model trained to generate a reward score for a model-generated unit test case for a focal method, wherein the reward score is based on a unit test case having one or more of a plurality of static code quality properties, wherein the plurality of static code quality properties comprises an assertion, an invocation of the focal method, a name for the unit test case that describes the test case, and existence of a comment that describes the test case;
accessing a neural-based model trained to generate a unit test case for a focal method, wherein the neural-based model comprises a plurality of parameters generated via a cross-entropy loss; and
tuning the neural-based model to learn to predict a unit test case for a target focal method having one or more of the plurality of static code quality properties, wherein the tuning of the neural-based model comprises:
iteratively sampling a predicted unit test case generated by the neural-based model and a predicted unit test case generated by the tuned neural-based model for a tuning sample;
computing, by the reward model, a reward score for the predicted unit test case generated by the tuned neural-based model;
computing a reward-based loss for the predicted unit test case generated by the neural-based model and the predicted unit test case generated by the tuned neural-based model;
augmenting the reward-based loss with the reward score; and
updating parameters of the tuned neural-based model using a policy loss that is based on the augmented reward-based loss.

17. The hardware device of claim 16, wherein the plurality of static code quality properties further comprises a plurality of anti-patterns, wherein the plurality of anti-patterns comprises existence of a duplicate assertion, existence of conditional logic or exception handling code, existence of print statement, and/or existence of an empty test in the unit test case generated by the tuned neural-based model.

18. The hardware device of claim 16, wherein the reward model is trained to generate the reward score for a select one of the static code quality properties.

19. The hardware device of claim 16, wherein the neural-based model comprises a neural transformer model with attention.

20. The hardware device of claim 16, wherein the reward model comprises a neural transformer model with attention.
